(19) United States
(12) Patent Application Publication
(10) Pub. No.: US 2005/0002109 A1
(43) Pub. Date: Jan. 6, 2005

(54) Optical pick-up device, and optical disc drive including the same

(75) Inventor: Shinichi Tokuno, Higashi Hiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka (JP)

(21) Appl. No.: 10/879,562

(22) Filed: Jun. 28, 2004

(30) Foreign Application Priority Data
Jul. 1, 2003 (JP) 2003-189637

(51) Int. Cl. G02B 27/10; G02B 27/14

(52) U.S. Cl. 359/634

(57) ABSTRACT

An optical pick-up device comprising: at least two light sources for emitting laser beams of different wavelengths; a beam splitter for reflecting or transmitting the light beams from the light sources; the beam splitter including a wavelength selecting film which reflects substantially all of the light beam from one of the light sources and transmits substantially all of the light beam from the other light source, a collimator lens for collimating the light beams reflected or transmitted by the beam splitter; a rising mirror for reflecting the light beams collimated at the collimator lens for rising; an objective lens for transmitting the laser beams reflected at the rising mirror, at least two reflecting mirrors for reflecting, in advance, the light beam unnecessary for rising before entering the beam splitter, when the light beam is reflected at the rising mirror after being emitted from each light source and passing through the beam splitter and the collimator lens; and a front monitor PD for receiving the light beams and monitoring the quantity of light of the light beams reflected at the reflecting mirrors.

### CROSS-REFERENCE TO RELATED APPLICATION

This application is related to Japanese application No. 2003-189637 filed on Jul. 1, 2003, whose priority is claimed under 35 USC § 119, the disclosure of which is incorporated by reference in its entirety.

### BACKGROUND OF THE INVENTION

1. Field of the Invention

The present invention relates to an optical pick-up device and an optical disc drive including the same. More specifically, the present invention relates to an optical pick-up device used for reproducing information from an optical disc such as a CD (Compact Disc) or a DVD (Digital Versatile Disc) and recording information on such an optical disc, particularly, an optical pick-up device for detecting the quantity of light emitting from a laser with a front monitor method to control the power of the light beam, and an optical disc drive including the same.

2. Description of the Related Art

As a device for carrying out reproduction (reading out information) and recording (writing in information) of the optical disc, there has been known a semiconductor laser optical device disclosed in, for example, Japanese Unexamined Patent Publication No. 2002-270940.

The semiconductor laser optical device disclosed in the above publication, however, is not a device capable of carrying out reproduction and recording of two or more types of optical discs.

A device for carrying out reproduction and recording of two or more types of optical discs is, for example, a device capable of carrying out reproduction and recording of both the CD and the DVD. In such a device, laser beams of respective wavelengths must be used in accordance with the types of optical discs.

Thus, when carrying out reproduction and recording of both, for example, the CD and the DVD, it is required to use an optical pick-up device capable of inputting/outputting the laser beam for reading/writing information from/in the CD and, also, capable of inputting/outputting the laser beam for reading/writing information from/in the DVD.

Conventionally, in a semiconductor laser used in the optical pick-up device, the emission power level thereof often fluctuates due to temperature change in the environment used, and aging from time of use.

An approach has been made to perform power control by an APC (Auto Power Control) circuit to stabilize the power level of the light beam emitted toward an information recording medium such as the optical disc. A typical method of the APC includes a rear monitor method (internal monitor method) for monitoring the light beam emitted from an end face opposite to an irradiation face of the semiconductor laser, and a front monitor method (external monitor method) for monitoring the light beam emitted from an end face facing the irradiation face of the semiconductor laser.

However, the rear monitor method has some disadvantages in, for example, detecting accuracy; thus, the front monitor method is usually used. The front monitor method is a method of monitoring part of the light beam emitted from the semiconductor laser and feeding back the light beam to a driving circuit of the semiconductor laser to control the power of the light beam so as to be constant.

FIG. 8 shows a light output system of a conventional optical pick-up device using the front monitor method.

The optical pick-up device shown in FIG. 8 includes a first light source 1 for emitting a laser beam of a wavelength λ₁, a second light source 2 for emitting a laser beam of a wavelength λ₂, a beam splitter 6 formed by attaching two right-angle prisms 3, 4 by way of a wavelength selecting film 5, a front monitor PD (photodiode) 7, a collimator lens 8, and a rising mirror 9.

The wavelength selecting film 5 has the function of reflecting most of the laser beam of the wavelength λ₁ from the first light source 1 and transmitting several percent of the laser beam.

Thus, most of the laser beam of the wavelength λ₁, after being reflected by the wavelength selecting film 5, passes through the collimator lens 8, enters the rising mirror 9, is reflected by the rising mirror 9, and is then output through an objective lens (not shown). Further, the several percent of the laser beam of the wavelength λ₁ transmitted through the wavelength selecting film 5 enters the front monitor PD 7, where the quantity of light is detected by the front monitor PD 7.

The wavelength selecting film 5 also has the function of transmitting most of the laser beam of the wavelength λ₂ from the second light source 2 and reflecting several percent of the laser beam.

Thus, most of the laser beam of the wavelength λ₂, after being transmitted through the wavelength selecting film 5, is output through the collimator lens 8, the rising mirror 9, and the objective lens (not shown). The several percent of the laser beam of the wavelength λ₂ reflected by the wavelength selecting film 5 enters the front monitor PD 7, where the quantity of light is detected by the front monitor PD 7.

Therefore, the laser beams from the first light source 1 and the second light source 2 are emitted in the same light output path (the wavelength selecting film 5, the collimator lens 8, the rising mirror 9 and the objective lens), and enters the same front monitor PD 7.

The optical pick-up device of this type is required to be compact, and to be compatible to both optical discs, for example, the CD and the DVD.

As described above, in the conventional optical pick-up device using the front monitor method, several percent of the necessary laser beam must be guided to the front monitor PD by the wavelength selecting film; thus, the quantity of light emitted from the objective lens is not 100% of the necessary laser beam.

However, since the quantity of light emitted from the objective lens influences the writing speed in the writable optical pick-up device, it is desirable to avoid reduction in the quantity of emission light.

A general property of the semiconductor laser is that the wavelength fluctuates by several nm as the output becomes high. Here, since the attachment face of the beam splitter is the wavelength selecting film, the transmissivity and the reflectivity of the wavelength selecting film changes due to the wavelength fluctuation; thus, the quantity of light at a spot where light is collected on the optical disc by the objective lens changes.

Generally, the quantity of light emitted toward the front monitor PD is equal to or less than about 5% of the entire quantity of light of the light beam emitted from the semiconductor laser. Thus, if the transmissivity and the reflectivity of the wavelength selecting film at the beam splitter changes by 1%, the output of the front monitor PD changes by about 20%, the output of the emission light of the semiconductor laser changes by about 20%, and the quantity of light at the spot where the light is collected on the optical disc by the objective lens also changes by about 20%.

### SUMMARY OF THE INVENTION

The present invention is made in view of the above problems, and it is therefore an object of the present invention to provide an optical pick-up device in which a light beam unnecessary for reading and writing of an optical disc is guided to a front monitor PD, so that writing power can be output to the optical disc without loss and, even if the wavelength fluctuation occurs especially during high output in the semiconductor laser, the output fluctuation of the front monitor PD is reduced while maintaining the desired writing output to achieve high-quality reading/writing performance; and an optical disc drive including the same.

According to one aspect of the present invention, an optical pick-up device comprises: at least two light sources for emitting laser beams of different wavelengths; a beam splitter for reflecting or transmitting the light beams from the light sources; the beam splitter including a wavelength selecting film which reflects substantially all of the light beam from one of the light sources and transmits substantially all of the light beam from the other light source, a collimator lens for collimating the light beams reflected or transmitted by the beam splitter; a rising mirror for reflecting the light beams collimated at the collimator lens for rising; an objective lens for transmitting the laser beams reflected at the rising mirror, at least two reflecting mirrors for reflecting, in advance, the light beam unnecessary for rising before entering the beam splitter, when the light beam is reflected at the rising mirror after being emitted from each light source and passing through the beam splitter and the collimator lens; and a front monitor PD for receiving the light beams and monitoring the quantity of light of the light beams reflected at the reflecting mirrors.

According to the optical pick-up device configured as described above, the light beam unnecessary for reading or writing the optical disc are guided to the front monitor PD in advance by at least two reflecting mirrors arranged in front of the beam splitter, so that the writing power can be output to the optical disc without loss. Further, even if wavelength fluctuation occurs especially during high-output in the semiconductor laser, the quantity of light of the light beams reflected at the reflecting mirrors is monitored by the front monitor PD; thus, the output change of the front monitor PD is reduced while maintaining the desired writing output, thereby achieving high quality reading and writing performance.

### BRIEF DESCRIPTION OF THE DRAWINGS

FIG. 1 illustrates a configuration of a light output system of an optical pick-up device according to one preferred embodiment of the present invention;

FIG. 2 illustrates a configuration of guiding a light beam from a first light source to a front monitor PD in the optical pick-up device of FIG. 1;

FIG. 3 illustrates a configuration of guiding a light beam from a second light source to the front monitor PD in the optical pick-up device of FIG. 1;

FIG. 4 illustrates a positional relationship between a coupling lens and a reflecting mirror in the optical pick-up device of FIG. 1;

FIG. 5 illustrates an outer shape of the reflecting mirror in the optical pick-up device of FIG. 1;

FIG. 6 illustrates a configuration of a light output system of an optical pick-up device according to another preferred embodiment of the present invention;

FIG. 7 illustrates an arrangement relationship between the light source and the reflecting mirror in the optical pick-up device of FIGS. 1 and 6; and

FIG. 8 illustrates a configuration of a light output system of a conventional optical pick-up device.

### DESCRIPTION OF THE PREFERRED EMBODIMENTS

Preferably, the optical pick-up device according to the present invention further comprises: an auxiliary collimator lens for substantially collimating, in front of the beam splitter, the light beam emitted from one of the light sources and before being transmitted by the beam splitter, wherein one of the reflecting mirrors is arranged at the same position as the auxiliary collimator lens.

In such a configuration, of the light beam emitted from one of the light sources and before being reflected by the beam splitter, one of the reflecting mirrors reflects and guides the light beam unnecessary for reading and writing the optical disc to the front monitor PD. Further, of the light beam emitted from the other light source and before being transmitted through the beam splitter, the other reflecting mirror reflects and guides the light beam unnecessary for reading and writing the optical disc, that is, the light beam not passing through the auxiliary collimator lens to the front monitor PD, and is arranged at the same position as the auxiliary collimator lens.

Therefore, with such a configuration, the effect of outputting the writing power to the optical disc without loss can be reliably achieved with a simple configuration, and the arrangement of at least one reflecting mirror, among some optical elements having allocating restriction, can be conveniently arranged, thus allowing a slim optical pick-up device to be obtained.

Preferably, the auxiliary lens is cut into a D-shape from a round bar-like body so as to have a D-shaped cross section including one flat side face and one curved side face connected to the flat side face. In addition, preferably, the flat side face of the auxiliary collimator lens is a face parallel to the direction equivalent to a radial direction of the optical pick-up device.

According to the auxiliary collimator lens, a surface area where the light passes is made large in the radial direction allowing an actuator of the optical pick-up device to activate to a certain extent (e.g., about ±300 μm) in the radial direction.

Preferably, the collimator lens and the auxiliary collimator lens are arranged so as to sandwich the beam splitter, and the flat side face of the auxiliary collimator lens is arranged so as to face the light source of the light beam entering the auxiliary collimator lens.

According to such a configuration, the collimator lens may be used for the light beams of two light sources, and the light source of the light beam entering the auxiliary collimator lens is closer to the rising mirror side, thus allowing miniaturization of the optical pick-up device.

The reflecting mirror is, for example, configured from a trapezoidal prism in which one inclined surface is the reflecting surface.

According to such a configuration, due to the restriction of the component allocation of the optical pick-up device in which only about 1 mm square can be taken up by the mirror surface, if the flat mirror is used, the handlability thereof is difficult and determination between the mirror surface and the non-mirror surface becomes difficult during assembling, but with the trapezoidal prism in which one inclined surface is the reflecting surface, such problems can be solved.

An attenuator for receiving and attenuating the light beam reflected at each of the reflecting mirror may be arranged in front of the front monitor PD.

When such an attenuator is arranged, if the quantity of light emitted from the light source and received by the front monitor PD via the reflecting mirror is much greater than the desired value, the quantity of light thereof can be attenuated. Examples of the attenuator may include a light attenuating plate, a pin hole plate, a light blocking body and the like.

Preferably, the quantity of light entering the front monitor PD is variable by changing the arrangement position of the reflecting mirror and/or the effective reflecting surface area.

According to such a front monitor PD, due to the allocated position of the reflecting mirror and/or the effective reflecting surface area, the quantity of light entering the front monitor PD can be individually changed at each light source.

Preferably, the quantity of light entering the front monitor PD is variable by changing the reflectivity of each reflecting mirror.

According to such a front monitor PD, by changing the reflectivity of the reflecting mirror such that the quantity of light from each light source to the front monitor PD is a predetermined value, the variance of the component properties of the reflecting mirror, the variance of the component properties of the front monitor PD and the like can be absorbed, and the photoelectric converged voltage can be electrically adjusted to a predetermined value with a volume resistance.

According to another aspect of the present invention, an optical disc drive comprises the optical pick-up device according to the first aspect of the present invention.

According to the optical disc drive configured as described above, by guiding, in advance, the light beam unnecessary in reading or writing an optical disc to the front monitor PD by at least two reflecting mirrors arranged in front of the beam splitter, the writing power can be output to the optical disc without loss. Further, even if wavelength fluctuation occurs especially during high output in the semiconductor laser, by monitoring the quantity of light of the light beams reflected at the reflecting mirrors with the front monitor PD, the output fluctuation of the front monitor PD can be reduced while maintaining the desired writing output; thus, high quality reading/writing performance can be achieved.

Two preferred embodiments of the present invention will now be described with reference to the accompanying drawings. It is to be noted that the present invention is not limited to the embodiments.

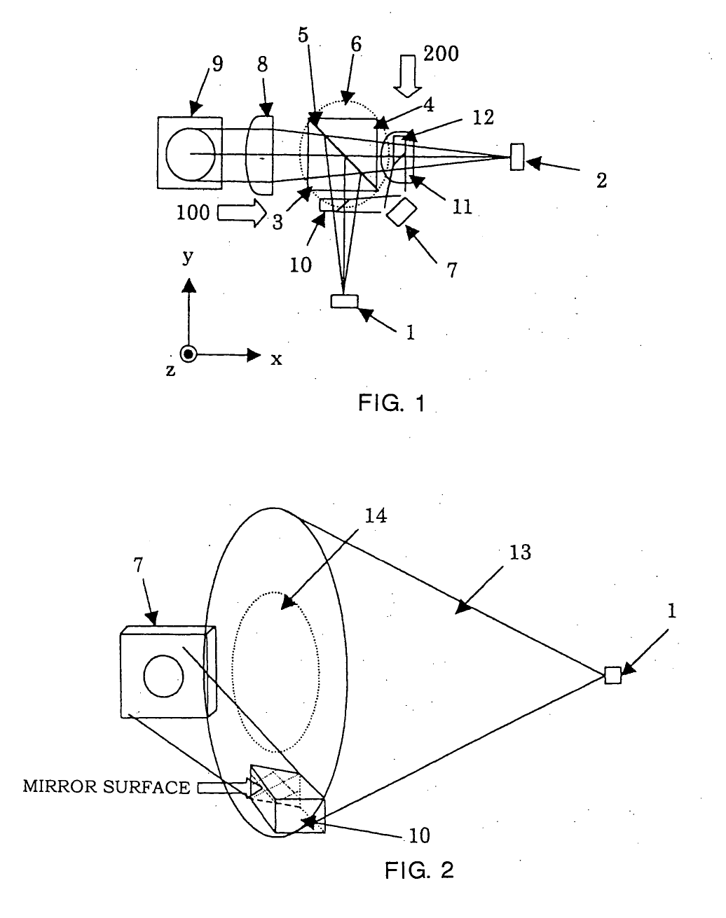

FIG. 1 shows a light output system of an optical pick-up device according to one preferred embodiment of the present invention. The optical pick-up device includes a first light source 1, a second light source 2, a beam splitter 6 formed by attaching two right-angle prisms 3, 4 with a wavelength selecting film 5, a front monitor PD 7, a collimator lens 8, a rising mirror 9, a reflecting mirror D 10, a reflecting mirror C 11, and an objective lens (not shown).

The first light source 1 emits a laser beam of a wavelength λ₁. The second light source 2 emits a laser beam of a wavelength λ₂. The beam splitter 6 reflects the light beam from the first light source 1, and transmits the light beam from the second light source 2. That is, the wavelength selecting film 5 in the beam splitter 6 reflects substantially 100% of the light beam from the first light source 1, and transmits substantially 100% of the light beam from the second light source 2.

The collimator lens 8 collimates the light beam reflected or transmitted at the beam splitter 6. The rising mirror 9 reflects the light beam collimated at the collimator lens 8 for rising. The objective lens transmits the laser beam reflected at the rising mirror 9.

In order to miniaturize the optical pick-up device, the second light source 2 must be arranged closer to the rising mirror 9 side. The collimator lens 8 and a coupling lens 12 are arranged with the beam splitter 6 sandwiched therebetween, so that the light beam from the second light source 2 becomes a parallel beam. The coupling lens 12 functions as an auxiliary collimator lens which collimates the light beam, emitted from the second light source 2 and before being transmitted through the beam splitter 6, to an almost parallel beam before entering the beam splitter 6.

The collimator lens 8 for the light beam from the first light source 1 is commonly used as that for the light beam from the second light source 2 for the purpose of reducing the number of components.

The wavelength selecting film 5 reflects substantially 100% of the laser beam of the wavelength λ₁ from the first light source 1. Thus, substantially 100% of the laser beam of the wavelength λ₁ reflected at the wavelength selecting film 5 enters the rising mirror 9 through the collimator lens 8, is reflected at the rising mirror 9, and is output by way of the objective lens.

The wavelength selecting film 5 transmits substantially 100% of the laser beam of the wavelength λ₂ from the second light source 2. The laser beam of the wavelength λ₂ passes through the coupling lens 12, and substantially 100% of the transmitted light is transmitted through the wavelength selecting film 5, and is output through the collimator lens 8, the rising mirror 9 and the objective lens.

Of the laser beam of the wavelength λhd 1, the unnecessary beam not used for writing to the optical disc or reproduction (reading out) of signal is reflected at the reflecting mirror D 10. This laser beam enters the front monitor PD 7, and the quantity of light is detected at the front monitor PD 7.

FIG. 2 shows the optical pick-up device seen from direction 100 in FIG. 1. The laser beam of the wavelength λ₁ is spread as indicated with reference numeral 13, and the region used for writing to the optical disc or for reproduction of the signal is only the region indicated with reference numeral 14. The reflecting mirror D 10 is arranged as shown in the figure, and detection of the quantity of light is performed by guiding the light beam not necessary during writing or during reproduction of the signal to the front monitor PD 7.

Of the laser beam of the wavelength λ₂, the unnecessary light beam not used for writing to the optical disc or for reproduction of the signal is reflected at the reflecting mirror C 11 arranged at the same position as the coupling lens 12, and enters the front monitor PD 7, where the quantity of light is detected at the front monitor PD 7.

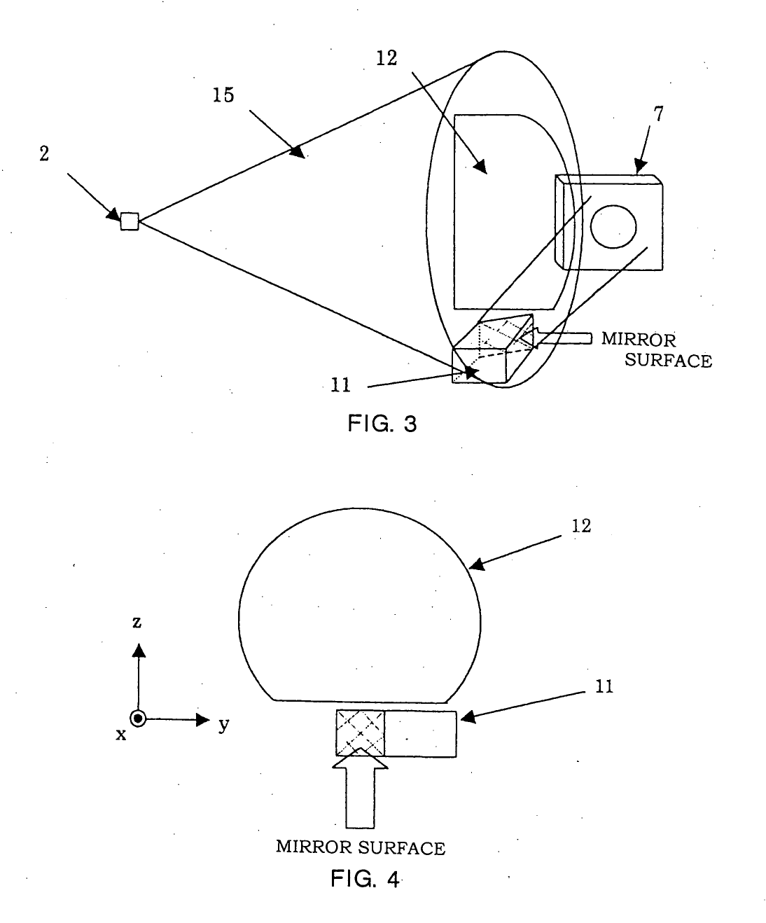

FIG. 3 shows the optical pick-up device seen from direction 200 in FIG. 1. The laser beam of the wavelength λ₂ is spread as indicated with reference numeral 15, and the light that does not pass through the coupling lens 12, arranged in front of the beam splitter 6, is the unnecessary beam. Thus, the reflecting mirror C 11 is arranged as shown in the figure, and detection of the quantity of light is performed by guiding the unnecessary light beam to the front monitor PD 7.

Thus, the light beams emitted from the first light source 1 and the second light source 2 both enter the same front monitor PD 7.

FIG. 4 shows the positional relationship between the coupling lens 12 and the reflecting mirror C 11. The coupling lens 12 is cut into a D-shape from a round bar-like body so as to form a D-shaped cross section including one flat side face and one curved side face, that is, a cylindrical side face connected to the flat side face.

The D-shaped cut face, that is, the flat side face of the coupling lens 12 desirably lies in the y-direction equivalent to the radial direction of the optical pick-up device. The reason for this is that an actuator of the optical pick-up device activates in the radial direction within a range of about ±300 μm; thus, a surface area where the light passes through must be made large in the radial direction. Therefore, the D-shaped cut face of the coupling lens 12 is a face parallel to the y-direction as shown in FIG. 4, and the reflecting mirror C 11 is arranged below the cut face.

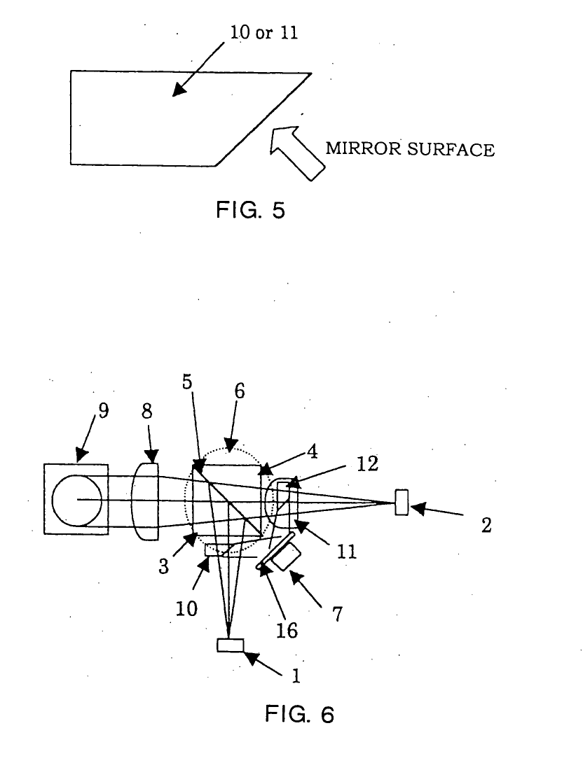

FIG. 5 shows the shape of the reflecting mirror D 10 and the reflecting mirror C 11. The reflecting mirrors D 10, C 11 include a trapezoidal prism in which the shape of the front surface is a trapezoid shape and in which one inclined plane acts as the reflecting surface.

The reflecting mirrors D 10, C 11 are formed from a trapezoidal prism for the following reasons. Due to the restriction in allocating the components of the optical pick-up device in which only 1 mm square can be occupied by the mirror surface, if a flat mirror is used, the handlability thereof becomes difficult, and determination between the mirror surface and the non-mirror surface becomes difficult during assembling. The use of trapezoidal prism in which one inclined surface acts as the reflecting surface resolves such problems.

FIG. 6 shows an optical pick-up device according to another preferred embodiment of the present invention. This optical pick-up device has the same configuration as shown in FIG. 1, but in addition, includes an attenuator 16 arranged in front of the front monitor PD 7 to attenuate the quantity of light entering the front monitor PD 7.

When the quantity of light emitted from the first light source 1 and the quantity of light emitted from the second light source 2 are both greater than a target value (desired value), the attenuator 16 is arranged in front of the front monitor PD 7 to attenuate the quantity of light entering thereto. Examples of the attenuator 16 may include a light attenuating plate, a pin hole plate, a light blocking body and the like.

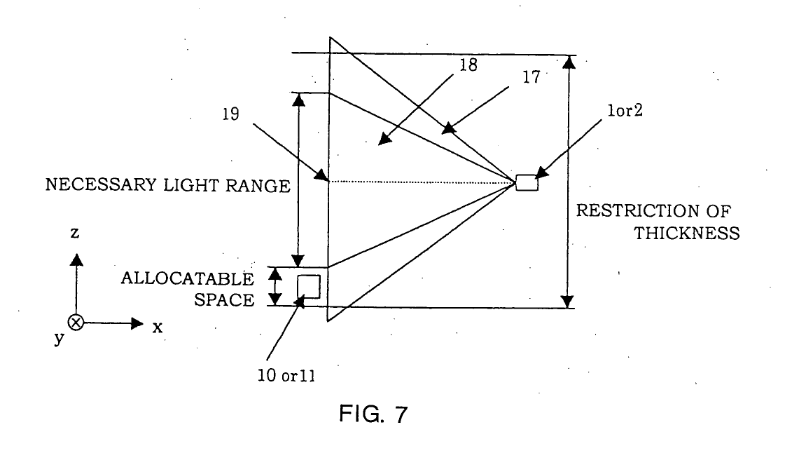

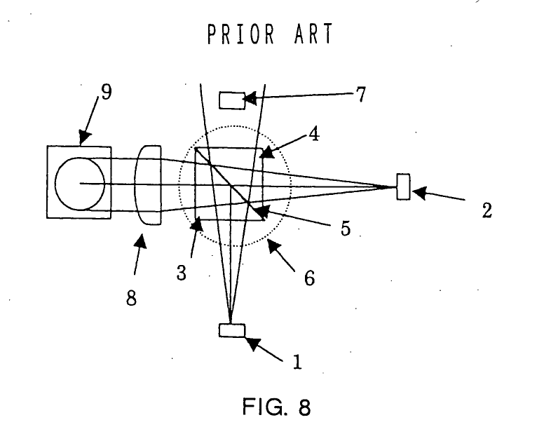

FIG. 7 shows an arrangement relationship of the light source 1 (2) and the reflecting mirror D 10 (C 11). In FIG. 7, the quantity of light of the laser beam emitted from the light source 1 (2) is the maximum at point 19, and the quantity of light decreases in the z-direction away from point 19. In other words, the quantity of light entering the front monitor PD 7 increases as the reflecting mirror D 10 (C 11) is closer to point 19, and the quantity of light entering the front monitor PD decreases as the reflecting mirror D 10 (C 11) is further away from point 19.

It is to be noted that the allocating position of the reflecting mirror D 10 (C 11) can not be freely designed.

In other words, the +z-direction is limited by a region (necessary light range) 18 used for writing to the optical disc or reproducing the signal, and the −z-direction is limited by a restriction on the thickness of the optical pick-up device. Further, the +x-direction has the same effect as the −z-direction and acts so that the quantity of light entering the front monitor PD 7 is small. On the other hand, the −x-direction has the same effect as the +z direction and acts so that the quantity of light entering the front monitor PD 7 is large.

However, the allocating space of the reflecting mirror D 10 (C 11) is also restricted in the x-direction in consideration of the peripheral optical components; thus, a suitable quantity of light must be obtained within the range of the restriction. The effective reflecting surface area of the reflecting mirror D 10 (C 11) must also be changed within the range of restriction of thickness and restriction of necessary light, similar to the allocating or arrangement restriction.

A method of changing the quantity of light entering the front monitor PD 7 includes changing the reflectivity of the reflecting mirror D 10 (C 11).

In this method, the restriction of the optical pick-up device has no influence. However, the reflectivity can not be equal to or more than 100%; thus, the quantity of light can not be increased. Further, when the reflectivity is extremely small such as, for example, 10%, if the reflectivity of the reflecting mirror D 10 (C 11) is changed by 1%, the output of the front monitor PD 7 changes by about 10%. Further, the output of the emission light of the semiconductor laser changes by about 10%, and the quantity of light at the spot where light is collected on the optical disc by the objective lens changes by about 10%; thus, the conventional problem can not be solved.

In consideration of the above problem, it is desirable to have the quantity of light entering the front monitor PD 7 at a desired value by means of the effective reflecting surface area and the arrangement of the reflecting mirror D 10 (C 11) within the restrictions of the optical pick-up device. It is not, on the contrary, desirable to have the reflectivity extremely small.

A photoelectric converted voltage is electrically adjusted to a predetermined value with a volume resistance so that the quantity of light from the two light sources 1, 2 entering the front monitor PD 7 is at the predetermined value, and so that the variation of component properties of the reflecting mirror D 10 (C 11) and the variation of the component properties of the front monitor PD 7 are absorbed.

The adjustment range of the volume resistance is generally about 0.5 times to 2.0 times; thus, in consideration of the variation of the component properties, the device should be designed so that the quantity of light is within the range.

Therefore, the quantity of light emitted from two light sources 1, 2 can be controlled with one front monitor PD 7.

According to the optical pick-up device and the optical disc drive equipped with the optical pick-up device according to the present invention, by guiding the light beam unnecessary for reading and writing of the optical disc to the front monitor PD, the writing power can be output to the optical disc without loss, and even if wavelength fluctuation occurs especially during high output in the semiconductor laser, the output fluctuation of the front monitor PD 7 can be reduced while maintaining the desired writing output to achieve a high-quality reading/writing performance.

1. An optical pick-up device comprising:
at least two light sources for emitting laser beams of different wavelengths;
a beam splitter for reflecting or transmitting the light beams from the light sources;
the beam splitter including a wavelength selecting film which reflects substantially all of the light beam from one of the light sources and transmits substantially all of the light beam from the other light source,
a collimator lens for collimating the light beams reflected or transmitted by the beam splitter;
a rising mirror for reflecting the light beams collimated at the collimator lens for rising;
an objective lens for transmitting the laser beams reflected at the rising mirror,
at least two reflecting mirrors for reflecting, in advance, the light beam unnecessary for rising before entering the beam splitter, when the light beam is reflected at the rising mirror after being emitted from each light source and passing through the beam splitter and the collimator lens; and
a front monitor PD for receiving the light beams and monitoring the quantity of light of the light beams reflected at the reflecting mirrors.

2. The optical pick-up device according to claim 1, further comprising:
an auxiliary collimator lens for substantially collimating, in front of the beam splitter, the light beam emitted from one of the light sources and before being transmitted by the beam splitter, wherein
one of the reflecting mirrors is arranged at the same position as the auxiliary collimator lens.

3. The optical pick-up device according to claim 2, wherein
the auxiliary lens is cut into a D-shape from a round bar-like body so as to have a D-shaped cross section including one flat side face and one curved side face connected to the flat side face.

4. The optical pick-up device according to claim 3, wherein
the flat side face of the auxiliary collimator lens is a face parallel to the direction equivalent to a radial direction of the optical pick-up device.

5. The optical pick-up device according to claim 3, wherein
the collimator lens and the auxiliary collimator lens are arranged so as to sandwich the beam splitter, and the flat side face of the auxiliary collimator lens is arranged so as to face the light source of the light beam entering the auxiliary collimator lens.

6. The optical pick-up device according to claim 1, wherein
the reflecting mirror is made of a trapezoidal prism having one inclined surface as a reflecting surface.

7. The optical pick-up device according to claim 1, further comprising:
an attenuator for receiving and attenuating the light beam reflected at each reflecting mirror, which is arranged before the front monitor PD.

8. The optical pick-up device according to claim 1, wherein
the quantity of light entering the front monitor PD is variable by changing the arrangement position of the reflecting mirror and/or the effective reflecting surface area.

9. The optical pick-up device according to claim 1, wherein
the quantity of light entering the front monitor PD is variable by changing the reflectivity of each reflecting mirror.

10. An optical disc drive comprising:
the optical pick-up device according to any one of claims 1 to 9.
